(19) United States
(12) Patent Application Publication
(10) Pub. No.: US 2013/0051471 A1
(43) Pub. Date: Feb. 28, 2013

(54) IMAGE FRAME INTERPOLATION METHOD AND APPARATUS

(71) Applicants: Tae-gyoung AHN, Yongin-si (KR); Jun-ho CHO, Siheung-si (KR); Jae-hyun KIM, Seoul (KR); Se-hyeok PARK, Seoul (KR); Hyun-wook PARK, Daejeon (KR); Hyung-jun LIM, Daejeon (KR)

(72) Inventors: Tae-gyoung AHN, Yongin-si (KR); Jun-ho CHO, Siheung-si (KR); Jae-hyun KIM, Seoul (KR); Se-hyeok PARK, Seoul (KR); Hyun-wook PARK, Daejeon (KR); Hyung-jun LIM, Daejeon (KR)

(73) Assignees: KOREA ADVANCED INSTITUTE OF SCIENCE AND TECHNOLOGY, Daejon-si (KR); SAMSUNG ELECTRONICS CO., LTD., Suwon-si (KR)

(21) Appl. No.: 13/598,108

(22) Filed: Aug. 29, 2012

(30) Foreign Application Priority Data
Aug. 29, 2011 (KR) 10-2011-0086565

(51) Int. Cl. H04N 7/32

(52) U.S. Cl. 375/240.15; 375/E07.125

(57) ABSTRACT

An image frame interpolation method and apparatus for determining an object and a background according to a degree of similarity between corresponding areas of a first image frame and a second image frame used for interpolation in every predetermined data unit of a third image frame interpolated between the first image frame and the second image frame and interpolating an object area of the third image frame by using object areas existing in original image frames.

### CROSS-REFERENCE TO RELATED PATENT APPLICATION

This application claims the benefit of Korean Patent Application No. 10-2011-0086565, filed on Aug. 29, 2011, in the Korean Intellectual Property Office, the disclosure of which is incorporated herein in its entirety by reference.

### BACKGROUND

1. Field

Methods and apparatuses consistent with exemplary embodiments relate to an image frame interpolation method and apparatus, and, more particularly, to a method and apparatus for changing the frame rate of a moving picture by generating new frames to be interpolated between the original frames of the moving picture.

2. Description of the Related Art

The recent availability and pervasiveness of economical, high quality displays has resulted in an increased demand for a substantial amount of high-resolution video in various-sized image formats. The availability of bandwidth, however, is typically a factor that necessitates the transmission of high-resolution data in a reduced bit rate form. This is done so as to make the data fit within an allowed range of the available bandwidth by considering a bit bandwidth. The result of this reduction, however, may visibly deteriorate the subjective image quality of the thus-transformed high-resolution video.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One approach to preventing such deterioration of image quality, that may occur due to the reduction of the bit rate, involves changing the frame rate of the original video. For example, when the frame rate of an original moving picture is 60 Hz, the frame rate may be changed to 120 Hz or 240 Hz by generating interpolation frames to be interpolated between frames of the original moving picture. Because of the change in the frame rate, a moving picture with less afterimages may be generated and reproduced.

Exemplary embodiments relate to a method and apparatus for changing a frame rate, and a computer-readable recording medium storing a computer-readable program for executing the method. In particular, exemplary embodiments relate to a method and apparatus for post-processing an interpolated image frame to remove artifacts frequently occurring in the interpolated image frame due to wrong motion prediction and compensation with respect to a small object.

According to an aspect of an exemplary embodiment, there is provided an image frame interpolation method comprising: generating a motion vector by performing motion prediction based on a first image frame and a second image frame; interpolating a third image frame between the first image frame and the second image frame by performing motion compensation based on the first image frame, the second image frame, and the motion vector; selecting at least one of a corresponding area of the first image frame and a corresponding area of the second image frame according to a degree of similarity between the corresponding area of the first image frame and the corresponding area of the second image frame, wherein the first and the second image frames are used for interpolation in a predetermined data unit of the interpolated third image frame for every predetermined data unit of the interpolated third image frame; and replacing the predetermined data unit with the selected corresponding area; determining an object area of the first image frame and an object area of the second image frame based on the selected corresponding area; and interpolating an object area of the third image frame by using the object area of the first image frame and the object area of the second image frame.

According to an aspect of an exemplary embodiment, there is provided an image frame interpolation apparatus comprising: a motion predictor which generates a motion vector by performing motion prediction based on a first image frame and a second image frame; a frame interpolator which interpolates a third image frame between the first image frame and the second image frame by performing motion compensation based on the first image frame, the second image frame, and the motion vector; a motion direction predictor which selects at least one of a corresponding area of the first image frame and a corresponding area of the second image frame according to a degree of similarity between the corresponding area of the first image frame and the corresponding area of the second image frame, wherein the first and the second image frames are used for interpolation in a predetermined data unit of the interpolated third image frame for every predetermined data unit of the interpolated third image frame and replacing the predetermined data unit with the selected corresponding area; an object area determiner which determines an object area of the first image frame and an object area of the second image frame based on the selected corresponding area; and an object interpolator which interpolates an object area of the third image frame by using the object area of the first image frame and the object area of the second image frame.

According to another exemplary embodiment, there is provided an image frame interpolation method, comprising: obtaining first and second sequential image frames comprising a pair of actual frames; generating a motion vector for the pair of actual frames by carrying out motion prediction on a block-by-block basis, wherein the motion prediction block has a block size; generating an interpolated frame in between and based on the content of the pair of actual frames and on the motion vector; and post-processing the interpolated frame, comprising: processing the interpolated frame on a unit-by-unit basis, wherein the unit size is less than the block size; for each unit-sized area of the interpolated frame, identifying a pair of corresponding areas in the pair of actual frames; determining a degree of similarity between the identified pair of corresponding areas; when the degree of similarity is below a threshold, replacing the unit-sized area of the interpolated frame with a mean value of the pair of corresponding areas; and when the degree of similarity is above the threshold, replacing the unit sized area of the interpolated frame with a most similar one of the pair of corresponding areas.

### BRIEF DESCRIPTION OF THE DRAWINGS

The above and other features and advantages will become more apparent by describing in detail exemplary embodiments thereof with reference to the attached drawings in which:

FIG. 1 is a block diagram of an image frame interpolation apparatus according to an exemplary embodiment;

FIG. 2 is a reference diagram for describing a method of up-converting an original image frame rate in a frame interpolator of FIG. 1;

FIG. 3 is a reference diagram for describing artifacts that may occur in a third image frame generated by the frame interpolator of FIG. 1;

FIG. 4 is a reference diagram for describing a process of determining a substitution image in an interpolated image frame that is performed by a motion direction predictor of FIG. 1;

FIG. 5 is another reference diagram for describing the process of determining a substitution image in an interpolated image frame that is performed by the motion direction predictor of FIG. 1;

FIG. 6 is a reference diagram for describing an object interpolation process performed by an object interpolator of FIG. 1; and

FIG. 7 is a flowchart illustrating an image frame interpolation method according to an exemplary embodiment.

### DETAILED DESCRIPTION

The inventive concept will now be described more fully with reference to the accompanying drawings, in which exemplary embodiments are shown.

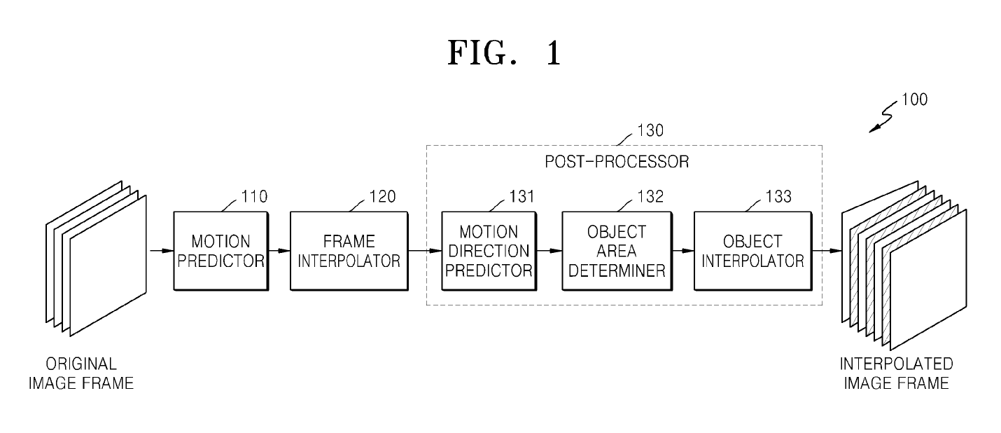

FIG. 1 is a block diagram of an image frame interpolation apparatus 100 according to an exemplary embodiment.

Referring to FIG. 1, the image frame interpolation apparatus 100 includes a motion predictor 110, a frame interpolator 120, and a post-processor 130.

The motion predictor 110 generates a motion vector by performing motion prediction between a first image frame and a second image frame that are sequential image frames in order to generate an image frame interpolated between input original image frames.

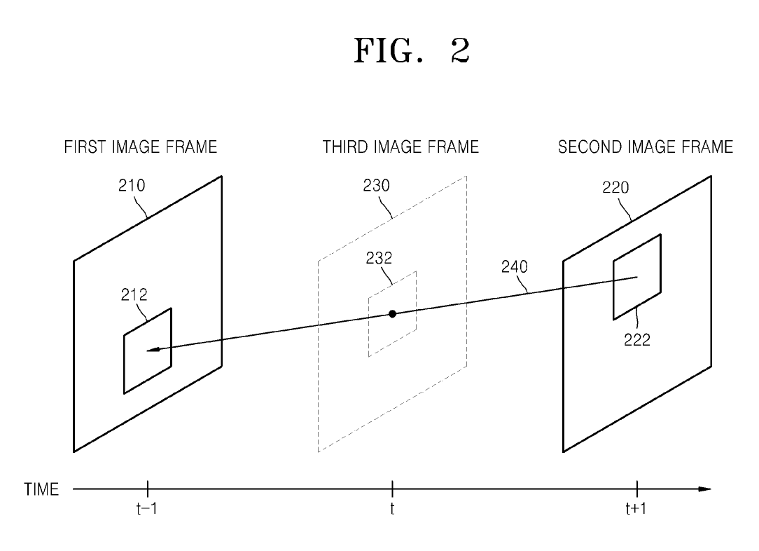

The frame interpolator 120 generates a third image frame to be interpolated between the first image frame and the second image frame based on the motion vector generated by the motion predictor 110. Here, there is no particular limitation to what method is used in generating the third image frame in the frame interpolator 120, and so any method of interpolating the third image frame, based on the motion vector, between the first image frame and the second image frame, may be applied to the exemplary embodiment. A specific example of a method of generating the third image frame by using the first image frame and the second image frame will be described in detail later with reference to FIG. 2.

The post-processor 130 includes a motion direction predictor 131, an object area determiner 132, and an object interpolator 133. The post-processor 130 removes artifacts existing in the third image frame by post-processing the third image frame output by the frame interpolator 120. In detail, the motion direction predictor 131 substitutes an image of the third image frame by using a corresponding area from either or both of the first image frame and the second image frame (i.e., the frames which were used as input to the frame interpolator 120), according to the similarity between the corresponding area of the first image frame and the corresponding area of the second image frame.

The object area determiner 132 determines an object area that exists in the first image frame and the second image frame, based on information regarding the corresponding area that was used as a substitute for the corresponding part of the third image frame in the motion direction predictor 131. The object area of the first image frame and the object area of the second image frame may be represented by an object map.

The object interpolator 133 interpolates an object area of the third image frame by using the object area of the first image frame and the object area of the second image frame. Hereinafter, the operation of the image frame interpolation apparatus 100 will be described in detail with reference to FIGS. 2 to 6.

FIG. 2 is a reference diagram for describing a method of up-converting an original image frame rate in the frame interpolator 120 of FIG. 1.

Referring to FIGS. 1 and 2, a motion vector 240 is predicted to generate a third image frame 230 to be interpolated between a first image frame 210 at a time t−1 and a second image frame 220 at a time t+1. The motion predictor 110 searches the first image frame 210 for a block 212 that is similar to a block 222 in the second image frame 220. The motion predictor 110 predicts the motion vector 240 based on the result of the aforementioned search. Although the motion predictor 110 generates the forward motion vector 240 in FIG. 2, the exemplary embodiment is not limited thereto, and the motion predictor 110 may generate a backward motion vector by performing motion prediction from the second image frame 220 based on the first image frame 210.

The frame interpolator 120 generates the third image frame 230 between the first image frame 210 and the second image frame 220 using the motion vector 240 that was generated by the motion predictor 110. The frame interpolator 120 may use any of a variety of known methods of interpolating an image frame between image frames based on a motion vector. For example, the frame interpolator may generate the third image frame 230 by using a motion-compensated frame interpolation (MCFI) method. The frame interpolator 120 may interpolate the third image frame 230 by using the motion vector 240 predicted with respect to the second image frame 220, using Equation 1.

$$\hat{f} ( i + \frac{{v}_{i , j}^{x}}{2} , j + \frac{{v}_{i , j}^{y}}{2} ) = \frac{1}{2} \{ {f}_{t - 1} ( i + {v}_{i , j}^{x} , j + {v}_{i , j}^{y} ) + {f}_{t + 1} ( i , j ) \} \qquad ( 1 )$$

In Equation 1: v_{i,j}^{x} denotes an x-axis component of the motion vector 240 at a position (i, j) of the second image frame 220 that is generated by the motion predictor 110; v_{i,j}^{y} denotes a y-axis component of the motion vector 240 at the position (i, j) of the second image frame 220 that is generated by the motion predictor 110; fₜ₋₁(x,y) denotes a pixel value at a position (x, y) of the first image frame 210; fₜ₊₁(x,y) denotes a pixel value at the position (x, y) of the second image frame 220; \hat{f}ₜ(x,y) and denotes a pixel value at the position (x, y) of the interpolated third image frame 230. Referring to Equation 1, the frame interpolator 120 interpolates the third image frame 230 by calculating a mean value of a corresponding area of the first image frame 210 and a corresponding area of the second image frame 220 based on the motion vector 240 generated by the motion predictor 110.

The frame interpolator 120 may interpolate the third image frame 230 based on a motion vector predicted with respect to each pixel of the third image frame 230, using Equation 2.

$$\hat{f} ( i , j ) = \frac{1}{2} \{ {f}_{t - 1} ( i + \frac{{v}_{i , j}^{x}}{2} j + \frac{{v}_{i , j}^{y}}{2} ) + {f}_{t + 1} ( i - \frac{{v}_{i , j}^{x}}{2} j - \frac{{v}_{i , j}^{y}}{2} ) \} \qquad ( 2 )$$

In equation 2, v_{i,j}^{x} and v_{i,j}^{y} denote motion vectors in x-axis and y-axis direction that are predicted at a position (i, j) of the third image frame 230, respectively, and the other parameters are the same as those of Equation 1. The motion vectors in the interpolated third image frame 230 may be predicted by using various known methods, without any particular limitation as to whether the direction is forward or backward along motion vectors with respect to the first image frame 210 and the second image frame 220.

A number of situations can give rise to various artifacts. The situations, for example, include when a small object exists, or when an object moves quickly in the first image frame 210 and the second image frame 220. The artifacts that might occur include that the image might not be uniform in the third image frame 230, or a ghost artifact (in which an image is shown more than once) may occur, or an object originally existing in the third image frame 230 may disappear.

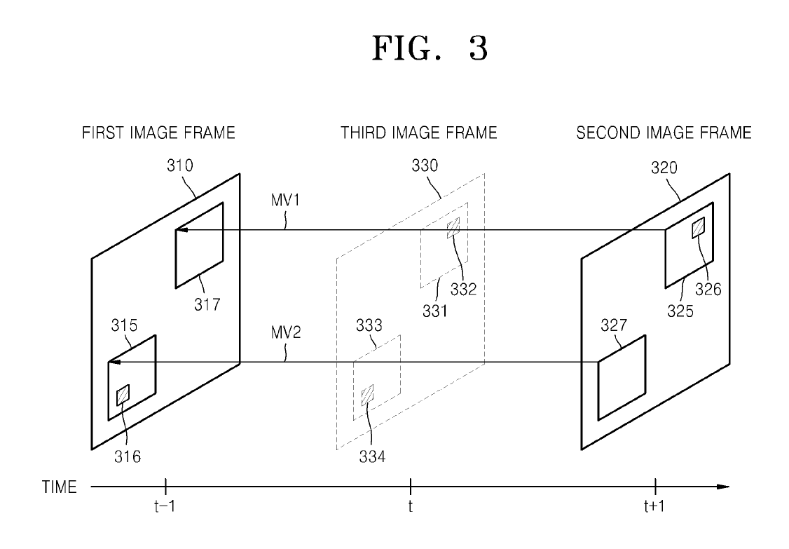

FIG. 3 is a reference diagram for describing artifacts that may occur in a third image frame generated by the frame interpolator 120 of FIG. 1.

Referring to FIG. 3, as described above, the frame interpolator 120 generates a motion vector by performing motion prediction between a first image frame 310 and a second image frame 320, and interpolates a third image frame 330 by using a corresponding area indicated by the motion vector. For example, as shown in FIG. 3, it is assumed that two motion vectors, MV1 and MV2 have been determined. The motion vector MV1 indicates that area 317 of first image frame 310 and area 325 of second image frame 320 correspond to each other. This correspondence is determined as a result of motion detection carried out by the motion predictor 110. Likewise, motion vector MV2 indicates that area 315 of the first image frame 310 and area 327 of second image frame 320 correspond, one to another.

In this example, it is assumed that objects 316 and 326 are smaller than the block size that is used for the motion detection, and that they exist in the first image frame 310 and the second image frame 320, respectively. Because the motion predictor 110 predicts a motion vector based on a sum of absolute difference (SAD) between the first image frame 310 and the second image frame 320 on a block by block, a small object (i.e., smaller than a block unit) may result in a wrong prediction.

In the above example, although the motion vector MV1 ought to be predicted so that the area 325 of the second image frame 320 is indicated as corresponding to the second corresponding area 315 of the first image frame 310. Unfortunately, in this example, the motion vector MV1 may be wrongly predicted so that the first block 325 matches with the first corresponding area 317 instead of 315. The effect of this incorrect prediction is felt in the third image frame 330. That is, in a first interpolation area 331 of the third image frame 330, interpolated by using a mean value of the first block 325 and the first corresponding area 317 based on the wrongly predicted motion vector MV1, a ghost object 332 may appear due to the object 326 existing in the first block 325. Similarly, in a second interpolation area 333 of the third image frame 330 interpolated by using a mean value of the second block 327 and the second corresponding area 315 based on the wrongly predicted motion vector MV2, a ghost object 334 may appear due to the object 316 existing in the second corresponding area 315. Thus, third image frame 330 might show two objects 332 and 334, instead of only one object, and the two objects 332 and 334 are in the wrong location so that a skipping effect might be noticed.

The post-processor 130 helps remedy such situations by performing post-processing to remove artifacts that may exist in an interpolated frame image produced according to various methods.

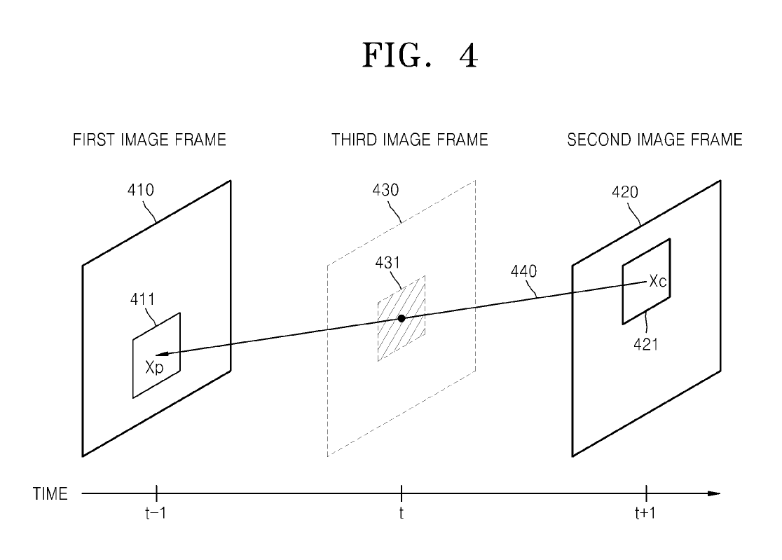

FIG. 4 is a reference diagram for describing a process of determining a substitution image in an interpolated image frame that is performed by the motion direction predictor 131 of FIG. 1.

Referring to FIG. 4, the motion direction predictor 131 substitutes an image in a data unit by using any one or both of a corresponding area of a first image frame 410 and a corresponding area of a second image frame 420, which are used for interpolation, every data unit having a predetermined size in a third image frame 430 (i.e., the image that was previously interpolated by the frame interpolator 120). Here, the data unit has a size smaller than a predetermined-sized block for which motion prediction is performed by the motion predictor 110. The data unit may, for example, have a size smaller than that of a 16×16 macro block when the motion prediction is performed on a 16×16 macro block basis. Because the motion direction predictor 131 is to identify an area for which motion compensation is performed in one direction by using any one of the first image frame 410 and the second image frame 420 to correct a wrong motion prediction direction of a small object, the motion direction predictor 131 preferably processes image data in a data unit of a size smaller than a block size used for motion prediction. When hard resources are backed up, the motion direction predictor 131 may replace the data unit with a pixel unit.

The motion direction predictor 131 replaces a data unit 431 of the third image frame 430 with another area, selected based on a degree of similarity between a corresponding area Xp 411 of the first image frame 410 and a corresponding area Xc 421 of the second image frame 420 used to interpolate the data unit 431. In other words, it replaces the data unit with one or the other area, or with a mean of the two areas, depending on how similar the one or the other areas are to each other. In detail, when an absolute difference |Xp−Xc| between the corresponding area Xp 411 of the first image frame 410 and the corresponding area Xc 421 of the second image frame 420 is less than a predetermined threshold (that is, when it is determined that the corresponding area Xp 411 of the first image frame 410 is sufficiently similar to the corresponding area Xc 421 of the second image frame 420), the data unit 431 is substituted by using a mean value (Xp+Xc)/2 between the corresponding area Xp 411 and the corresponding area Xc 421. When the third image frame 430 is generated based on the mean value (Xp+Xc)/2 between the corresponding area Xp 411 of the first image frame 410 and the corresponding area Xc 421 of the second image frame 420, this substituting process may be omitted.

When the absolute difference |Xp−Xc| between the corresponding area Xp 411 of the first image frame 410 and the corresponding area Xc 421 of the second image frame 420 is greater than the predetermined threshold (i.e., the two areas are not sufficiently similar), the motion direction predictor 131 substitutes the data unit 431 by selecting a corresponding area similar to the data unit 431. In detail, the motion direction predictor 131 replaces the data unit 431 by selecting a corresponding area similar to a mean value of surrounding pixels processed before the data unit 431. If it is assumed that the mean value of the surrounding pixels processed before the data unit 431 is x′, when |Xp−x′|<|Xc−x′|, (i.e., when the corresponding area Xp 411 of the first image frame 410 is more similar to the mean value of the surrounding pixels of the data unit 431 than the corresponding area Xc 421 of the second image frame 420) it is determined that the data unit 431 is similar to the corresponding area Xp 411, and the data unit 431 is substituted with the corresponding area Xp 411 of the first image frame 410. That is to say, the data unit 431 is replaced with the data unit 411. In the other case, the motion direction predictor 131 replaces data unit 431 with the corresponding area Xc 421 of the second image frame 420.

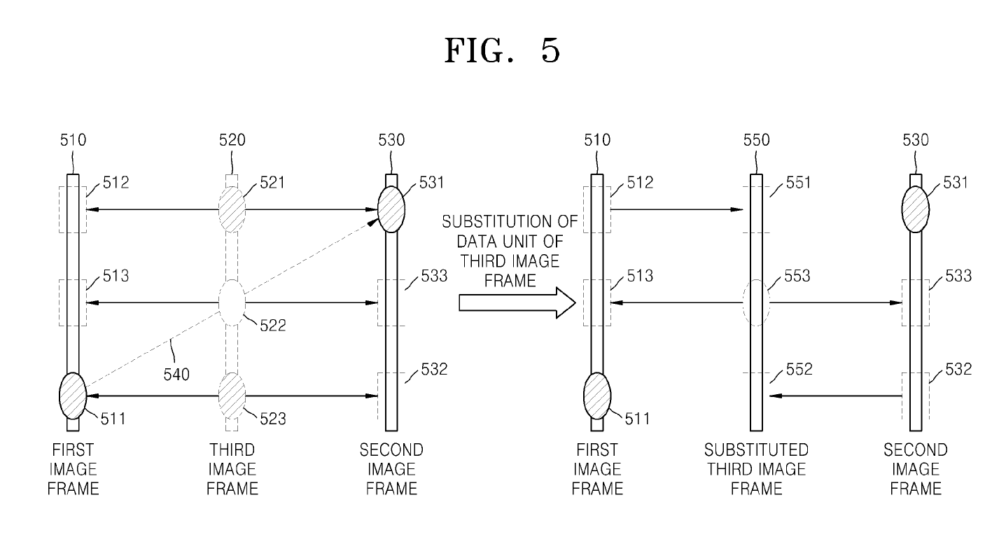

FIG. 5 is another reference diagram for describing the process of determining a substitution image in an interpolated image frame that is performed by the motion direction predictor 131 of FIG. 1. In FIG. 5, it is assumed that small, fast-moving objects 511 and 531 exist in a first image frame 510 and a second image frame 530, respectively, and a third image frame 520 is interpolated by using corresponding areas of the first image frame 510 and the second image frame 530 as shown by the direction of the arrows of FIG. 5. As described with reference to FIG. 3, when interpolation is performed by using a wrong motion prediction of a small object, an object 522 which ought to exist in the third image frame 520 might not exist in the third image frame 520, or ghost objects 521 and/or 523 which are not supposed to exist may exist in the third image frame 520.

Thus, as described above, the motion direction predictor 131 selects at least one of corresponding areas of the first image frame 510 and the second image frame 530, which are used for a data unit based interpolation in every data unit of the third image frame 520. This selection is based on a similarity between the corresponding areas of the first image frame 510 and the second image frame 530. The motion direction predictor replaces every data unit of the interpolated frame based on the selected corresponding area.

For example, the motion direction predictor 131 measures the similarity between corresponding areas 512 and 531 used to interpolate a data unit 521. As shown in FIG. 5, if it is assumed that the similarity between the corresponding area 512 of the first image frame 510 and the corresponding area 531 of the second image frame 530 is small (since one is a background and the other is an object), the motion direction predictor 131 substitutes the data unit 521 by using the corresponding area 512 of the first image frame 510 that is similar to surrounding pixels of the data unit 521. That is, the data unit 521 is substituted with the corresponding area 512 of the first image frame 510 in a substituted third image frame 550.

Likewise, the motion direction predictor 131 measures the similarity between corresponding areas 513 and 533 used to interpolate a data unit 522. As shown in FIG. 5, if it is assumed that the similarity between the corresponding area 513 of the first image frame 510 and the corresponding area 533 of the second image frame 530 is high (since both are backgrounds), the motion direction predictor 131 substitutes the data unit 522 by using a mean value of the corresponding area 513 of the first image frame 510 and the corresponding area 533 of the second image frame 530. That is, the data unit 522 is replaced with the mean value of the two corresponding areas 513 and 533 in the substituted third image frame 550, as represented by area 553. As described above, when the frame interpolator 120 uses a mean value of a first image frame and a second image frame, this process may be omitted (i.e., the area at 522 is already the mean value in such a scenario, so there is no added benefit to again performing the mean value calculation).

In addition, the motion direction predictor 131 measures the similarity between corresponding areas 511 and 532 used to interpolate a data unit 523. As shown in FIG. 5, if it is assumed that the similarity between the corresponding area 511 of the first image frame 510 and the corresponding area 532 of the second image frame 530 is low (since an object and a background are likely to be dissimilar), the motion direction predictor 131 replaces the data unit 523 by using the corresponding area 532 of the second image frame 530 that is similar to surrounding pixels of the data unit 523. That is, the data unit 523 is substituted with the corresponding area 532 of the second image frame 530 in the substituted third image frame 550.

As shown in FIG. 5, the ghost objects 521 and 523 existing in the initially interpolated third image frame 520 may be at least removed in the substituted third image frame 550 as a result of the above-identified processing by the motion direction predictor 131. The object area determiner 132 and the object interpolator 133 interpolate an object area in a substituted third image frame.

In detail, the object area determiner 132 determines object areas, existing in the first image area and the second image frame, based on corresponding area information of the first image area and the second image frame selected by the motion direction predictor 131 for data unit based replacement of the third image frame. Referring to FIG. 5 again, because the motion direction predictor 131 selects the corresponding area 512 of the first image frame 510 to process the data unit 521, the object area determiner 132 determines the non-selected corresponding area 531 of the second image frame 530 to be an object area. Likewise, the object area determiner 132 determines the corresponding area 511 of the first image frame 510, which is not selected when the motion direction predictor 131 processes the data unit 521, as an object area. In other words, the areas that were not used in this example tended to be areas that were dissimilar from the surrounding background pixels, and it is these unused areas that were marked as object containing areas.

The object area determiner 132 may generate an object map by setting 0 as a default value for every pixel of the first image frame 510 and the second image frame 530 and then setting only pixels determined as being in an object area as described above to 1.

The object interpolator 133 interpolates the object area of the third image frame by using the object areas that were determined by the object determiner 132, namely, object area 511 of the first image frame 510 and the object area 531 of the second image frame 530.

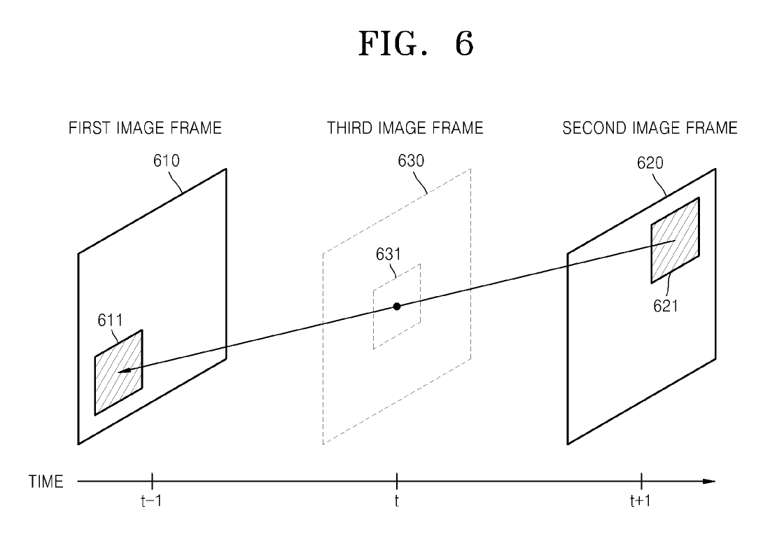

FIG. 6 is a reference diagram for describing an object interpolation process performed by the object interpolator 133 of FIG. 1.

Referring to FIG. 6, if the object area determiner 132 determines an object area 611 of a first image frame 610 and an object area 621 of a second image frame 620, the object interpolator 133 determines a position of an object in a third image frame 630 based on a position difference between the object area 611 of the first image frame 610 and the object area 621 of the second image frame 620. It then interpolates an object area 631 of the third image frame 630 by using a mean value of the object area 611 of the first image frame 610 and the object area 621 of the second image frame 620. That is, the object interpolator 133 determines an interpolation position in which the object area 631 is supposed to exist in the third image frame 630, by considering a position difference and a temporal distance between the object area 611 of the first image frame 610 and the object area 621 of the second image frame 620 and interpolates an object at the determined interpolation position by using the mean value of the object area 611 of the first image frame 610 and the object area 621 of the second image frame 620. Because a process of determining the interpolation position is similar to an interpolation process according to the scaling of a motion vector, a detailed description thereof is omitted.

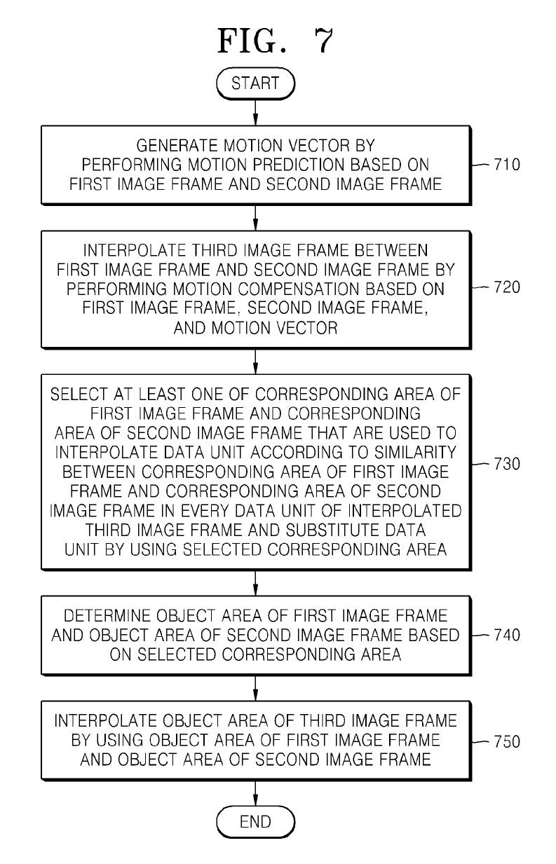

FIG. 7 is a flowchart illustrating an image frame interpolation method according to an exemplary embodiment.

Referring to FIG. 7, in operation 710, the motion predictor 110 generates a motion vector by performing motion prediction based on a first image frame and a second image frame.

In operation 720, the frame interpolator 120 interpolates a third image frame between the first image frame and the second image frame by performing motion compensation based on the first image frame, the second image frame, and the motion vector. As described above, because the current exemplary embodiment relates to post-processing of the third image frame generated in various methods, there is no particular limitation to the method of generating the third image frame.

In operation 730, the motion direction predictor 131 selects at least one of the corresponding areas of the first image frame and the second image frame. These areas are used for in every predetermined data unit of the interpolated third image frame for data unit-based interpolation. The selection is based on the degree of similarity between the corresponding areas of the first image frame and the second image frame. The motion direction predictor 131 replaces every data unit based on the selected corresponding area. As described above, the motion direction predictor 131 removes ghost images existing in the third image frame by replacing a data unit with any one of the corresponding areas used to interpolate the third image frame, the choice depending on the similarity between the corresponding areas.

In operation 740, the object area determiner 132 determines what areas of the first image frame or the second image frame may be object areas, based on which corresponding area was not selected by the motion direction predictor 131. As described above, the object area determiner 132 may determine a corresponding area, which is not selected from among the corresponding area of the first image frame and the corresponding area of the second image frame when a difference value between the corresponding areas is greater than a predetermined threshold, as an object area.

In operation 750, the object interpolator 133 interpolates an object area of the third image frame by using the object area of the first image frame and the object area of the second image frame that are determined by the object area determiner 132.

The previously mentioned exemplary embodiments help overcome the issue of position information of a fast moving, small object for which interpolation cannot be correctly performed in other image frame interpolation methods. According to the exemplary embodiments, such movement can be perceived, and thus a correct interpolation of the small object can be performed. In addition, by post-processing an image frame interpolated after dividing each of original image frames into an object area and a background area by using information regarding a small object, the small object can be prevented from disappearing from the interpolated image frame. Likewise, the display of ghost artifacts in the interpolated image frame can also be prevented.

While the inventive concept has been particularly shown and described with reference to exemplary embodiments thereof, it will be understood by those familiar with this field that various changes in form and details may be made therein without departing from the spirit and scope of the appended claims. In addition, a system according to the foregoing exemplary embodiments can also be embodied in the form of computer-readable codes on a non-transitory, computer-readable recording medium.

The computer-readable recording medium is any non-transitory data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be stored in a distributed fashion, over network-coupled computer systems, and the computer-readable code may be executed in a distributed fashion as well.

What is claimed is:

1. An image frame interpolation method comprising:
generating a motion vector by performing motion prediction based on a first image frame and a second image frame;
interpolating a third image frame between the first image frame and the second image frame by performing motion compensation based on the first image frame, the second image frame, and the motion vector;
selecting at least one of a corresponding area of the first image frame and a corresponding area of the second image frame according to a degree of similarity between the corresponding area of the first image frame and the corresponding area of the second image frame, wherein the first and the second image frames are used for interpolation in a predetermined data unit of the interpolated third image frame for every predetermined data unit of the interpolated third image frame; and
replacing the predetermined data unit with the selected corresponding area;
determining an object area of the first image frame and an object area of the second image frame based on the selected corresponding area; and
interpolating an object area of the third image frame by using the object area of the first image frame and the object area of the second image frame.

2. The image frame interpolation method of claim 1, wherein the interpolating of the third image frame is performed by using a mean value of the corresponding area of the first image frame and the corresponding area of the second image frame which are used for data unit based interpolation in every predetermined data unit of the interpolated third image frame based on the motion vector.

3. The image frame interpolation method of claim 1, wherein the replacing of the predetermined data unit comprises:
calculating a difference value between the corresponding area of the first image frame and the corresponding area of the second image frame used to interpolate the predetermined data unit;
when the difference value is less than a threshold, replacing the predetermined data unit by using a mean value of the corresponding area of the first image frame and the corresponding area of the second image frame;
when the difference value is greater than the threshold, selecting a corresponding area, from the corresponding area of the first image frame and the corresponding area of the second image frame, which is most similar to a mean value of the pixels surrounding the predetermined data unit; and
replacing the predetermined data unit with the selected corresponding area.

4. The image frame interpolation method of claim 3, wherein the determining of the object areas comprises determining a corresponding area, which is not selected from among the corresponding area of the first image frame and the corresponding area of the second image frame when the difference value is greater than the threshold, as an object area of a corresponding image frame.

5. The image frame interpolation method of claim 4, further comprising generating an object area map indicating the determined object areas.

6. The image frame interpolation method of claim 1, wherein the interpolating of the object area of the third image frame comprises using a mean value of the object area of the first image frame and the object area of the second image frame.

7. The image frame interpolation method of claim 1, wherein the predetermined data unit is smaller than a predetermined-sized block used for the motion prediction.

8. An image frame interpolation apparatus comprising:
a motion predictor which generates a motion vector by performing motion prediction based on a first image frame and a second image frame;
a frame interpolator which interpolates a third image frame between the first image frame and the second image frame by performing motion compensation based on the first image frame, the second image frame, and the motion vector;
a motion direction predictor which selects at least one of a corresponding area of the first image frame and a corresponding area of the second image frame according to a degree of similarity between the corresponding area of the first image frame and the corresponding area of the second image frame, wherein the first and the second image frames are used for interpolation in a predetermined data unit of the interpolated third image frame for every predetermined data unit of the interpolated third image frame and replacing the predetermined data unit with the selected corresponding area;
an object area determiner which determines an object area of the first image frame and an object area of the second image frame based on the selected corresponding area; and
an object interpolator which interpolates an object area of the third image frame by using the object area of the first image frame and the object area of the second image frame.

9. The image frame interpolation apparatus of claim 8, wherein the frame interpolator uses a mean value of the corresponding area of the first image frame and the corresponding area of the second image frame based on the motion vector.

10. The image frame interpolation apparatus of claim 8, wherein the motion direction predictor:
calculates a difference value between the corresponding area of the first image frame and the corresponding area of the second image frame used to interpolate the predetermined data unit,
when the difference value is less than a threshold, replaces the predetermined data unit by using a mean value of the corresponding area of the first image frame and the corresponding area of the second image frame, and
when the difference value is greater than the threshold, selects a corresponding area, from the corresponding area of the first image frame and the corresponding area of the second image frame, which is most similar to a mean value of the pixels surrounding the predetermined data unit and
replaces the data unit with the selected corresponding area.

11. The image frame interpolation apparatus of claim 10, wherein the object area determiner determines a corresponding area, which is not selected from among the corresponding area of the first image frame and the corresponding area of the second image frame when the difference value is greater than the threshold, as an object area of a corresponding image frame.

12. The image frame interpolation apparatus of claim 10, wherein the object area determiner generates an object area map indicating the determined object areas.

13. The image frame interpolation apparatus of claim 8, wherein the object interpolator generates an object area of the third image frame by using a mean value of the object area of the first image frame and the object area of the second image frame.

14. The image frame interpolation apparatus of claim 8, wherein the predetermined data unit is smaller than a predetermined-sized block used for the motion prediction.

15. A computer-readable recording medium storing a computer-readable program for executing the image frame interpolation method of claim 1.

16. An image frame interpolation method, comprising:
obtaining first and second sequential image frames comprising a pair of actual frames;
generating a motion vector for the pair of actual frames by carrying out motion prediction on a block-by-block basis, wherein the motion prediction block has a block size;
generating an interpolated frame in between and based on the content of the pair of actual frames and on the motion vector; and
post-processing the interpolated frame, comprising:
processing the interpolated frame on a unit-by-unit basis, wherein the unit size is less than the block size;
for each unit-sized area of the interpolated frame, identifying a pair of corresponding areas in the pair of actual frames;
determining a degree of similarity between the identified pair of corresponding areas;
when the degree of similarity is below a threshold, replacing the unit-sized area of the interpolated frame with a mean value of the pair of corresponding areas; and
when the degree of similarity is above the threshold, replacing the unit sized area of the interpolated frame with a most similar one of the pair of corresponding areas.

17. The method as set forth in claim 16, wherein, when the degree of similarity is above the threshold, the one of the pair of corresponding areas which is not the most similar one is identified as an object area.

18. The method as set forth in claim 17, wherein, when the pair of actual frames each has a corresponding object area, the object areas are used to carry out an object interpolation process with respect to the interpolated frame.

19. The method as set forth in claim 18, wherein the object interpolation process comprises:
determining a location for an object area of the interpolated frame based on location information of the object areas of the pair of actual frames; and
replacing the object area of the interpolated frame with content based on the content of the object areas of the actual frames.

20. The method as set forth in claim 19, wherein the replacing of the object area of the interpolated frame is carried out by replacing the content of the object area of the interpolated frame with a mean value of the object areas of the pair of actual frames.
